(19) United States
(12) Patent Application Publication
(10) Pub. No.: US 2005/0146186 A1
(43) Pub. Date: Jul. 7, 2005

(54) Seat device of vehicle

(75) Inventors: Kenji Kinnou, Hiroshima (JP); Eiji Kimoto, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Aki-gun (JP)

(21) Appl. No.: 10/991,473

(22) Filed: Nov. 19, 2004

(30) Foreign Application Priority Data
Dec. 18, 2003 (JP) 2003-420869
Aug. 24, 2004 (JP) 2004-244141

(51) Int. Cl. A47C 15/00; B60N 2/00

(52) U.S. Cl. 297/331

(57) ABSTRACT

In a vehicle having a cabin with an ingress-and-egress opening portion on its side provided between a front-wheel axle and a rear-wheel axle, there are provided plural passenger seats including a driver seat on a floor panel, a support member to support its seat cushion and seat back in such a manner that the seat cushion is selectively held in sitting state of a substantially horizontal position or in stored state of a substantially upright position, whereas the seat back is selectively held in first-use state of a substantially upright position or in second-use state of a substantially horizontal position, and seat rails to support the passenger seat movably in a longitudinal direction. An effective use of passenger seats can be improved, and an utility space in the cabin can be enlarged at need.

### BACKGROUND OF THE INVENTION

The present invention relates to a seat device of a vehicle, in which a cabin including an ingress-and-egress opening portion on its side face is provided between a front-wheel axle and a rear-wheel axle, comprising plural passenger seats including a driver seat which are disposed on a floor panel provided at a lower portion of the cabin.

Conventionally, the following seat storing structure of a vehicle including a front-row seat comprising an assistant seat disposed behind an instrument panel provided at a front portion in the cabin is known as shown in Japanese Patent Laid-Open Publication No. 2003-226175. Namely, the above-descried front-row seat is supported by a slide mechanism so as to move in the longitudinal direction of the vehicle and reach its foremost stored position beyond its normally-adjustable range for sitting, whereby the front-row seat can be stored by locating its seat cushion below the instrument panel when the seat is not used.

Also, a seat device of an automotive vehicle including a driver seat, an assistant seat and a rear seat behind them is known as shown in Japanese Patent Laid-Open Publication No. 2000-238560, in which there is provided a guide rail to support the assistant seat movably in the longitudinal direction between its position below a dash board and its normal use position beside the driver seat, whereby the assistant seat can be stored by being moved forward with its seat back folded on its seat cushion.

Storing the front-row seat by locating its seat cushion below the instrument panel during the non-use of seat, as shown in the above-described former publication, can provide a large space before a rear-row seat disposed behind the front-row seat. However, this seat storing structure of a vehicle has a problem that the front-row seat could not be used effectively. Because the seat is stored such that its seat back is located along the instrument panel, which may make it impossible for the seat to be used when it is stored.

Meanwhile, storing the assistant seat by moving it forward with its seat back folded on its seat cushion during the non-use of seat, as shown in the above-described latter publication, can use the assistant seat effectively by providing a cup holder or a tray on a back face of the seat back. However, such an use of the assistant seat is still limited, and therefore further improved utility has been desired.

### SUMMARY OF THE INVENTION

The present invention has been devised in view of the above-described problems, and an object of the present invention is to provide a seat device of a vehicle which can improve an effective use of passenger seats including the assistant seat and others, and enlarge an utility space in the cabin at need.

This object is solved by a seat device of a vehicle according to the present invention of claim 1. Preferred embodiments of the present invention are subject of the dependent claims.

According to the present invention, there is provided a seat device of a vehicle, in which a cabin including an ingress-and-egress opening portion on a side face thereof is provided between a front-wheel axle and a rear-wheel axle, comprising plural passenger seats including a driver seat, which are disposed on a floor panel provided at a lower portion of the cabin, a support member operative to support a seat cushion and a seat back of at least one of the passenger seats in such a manner that the seat cushion is selectively held in a sitting state of a substantially horizontal position or in a stored state of a substantially upright position with a front end thereof in the sitting state located upward, whereas the seat back is selectively held in a first-use state of a substantially upright position or in a second-use state of a substantially horizontal position with a lower end thereof in the first-use state located forward, and a seat rail operative to support said at least one of passenger seats such that the at least one of passenger seats moves forward in a longitudinal direction of the vehicle.

Accordingly, by holding the seat cushion in its stored state of the substantially upright position and moving forward the passenger seat with the seat back held in its second-use state of the substantially horizontal position along the seat rail, the passenger seat can be used as a temporary baby-care bed, in which the seat back performs as a bed body and the seat cushion performs as a protect member, and there can be also provided a large utility space behind the passenger seat.

According to a preferred embodiment, at least one of passenger seats supported by the support member comprises a front-row seat which is located at a front portion in the cabin, and a rear-row seat is provided behind the front-row seat.

Accordingly, by holding the seat cushion of the front-row seat including the assistant seat in its stored state of the substantially upright position and moving forward the front-row seat with the seat back held in its second-use state of the substantially horizontal position along the seat rail, the front-row seat can be used as the temporary baby-care bed with the large utility space behind it, and therefore the parent or somebody can easily take care of the baby on the seat, such as a diaper changing, sitting on the rear-row seat.

According to another preferred embodiment, there is provided an instrument panel extending in a vehicle width direction at a front end portion of the cabin, a recessed storing portion is formed at a portion of the instrument panel which corresponds to at least part of the front-row seat, and the front-row seat moves forward along the seat rail, whereby at least part of the front-row seat can be stored in the storing portion.

Accordingly, by moving the front-row seat forward along the seat rail and then storing at least part of the front-row seat in the storing portion formed at the instrument panel, the front-row seat can be used as the temporary baby-care bed and the rear space behind the front-row seat can be also enlarged effectively.

According to another preferred embodiment, the front-row seat moves forward along the seat rail with the seat cushion thereof being held in the stored state, whereby the seat cushion of the front-row seat can be stored in the storing portion.

Accordingly, by moving the front-row seat including the assistant seat forward along the seat rail with its seat cushion held in its stored state of the substantially vertical position and then storing the seat cushion in the storing portion formed at the instrument panel, the rear space behind the front-row seat can be enlarged effectively. Further, the front-row seat can be used as the temporary baby-care bed, maintaining such an enlarged utility rear space behind the front-row seat, when the seat back of the front-row seat is held in its second-use state of the substantially horizontal position.

According to another preferred embodiment, the front-row seat moves forward along the seat rail with the seat cushion thereof being held in the stored state and with the seat back thereof being held in the first-use state, whereby the seat cushion and seat back of the front-row seat can be stored in the storing portion.

Accordingly, by moving the front-row seat forward along the seat rail with its seat cushion and seat back held in their substantially upright positions and then storing the seat cushion and seat back in the storing portion formed at the instrument panel, a larger space can be provided behind the front-row seat.

According to another preferred embodiment, at least part of the seat rail supporting the front-row seat movably in the longitudinal direction of the vehicle and at least part of the seat rail supporting the rear-row seat movably in the longitudinal direction of the vehicle are formed of a common rail member.

Accordingly, because of commonality of the part of seat rails, manufacturing costs can be reduced with a decrease of the number of parts, and an attaching rigidity of the seat rails can be strengthened effectively, facilitating attachment works of the seat rails.

According to another preferred embodiment, the seat back of at least one of passenger seats supported by the support member in the second-use state is configured such that a height of a rear end portion thereof above a road surface is lower than that of a front end portion thereof above the road surface.

Accordingly, because the seat back is positioned in a slant state where its rear portion is lower, the baby's head placed on the front end portion of the seat back can be located at a higher level than the baby's feet placed on the rear end portion of the seat back, resulting in a stable position of the baby on the bed.

According to another preferred embodiment, at least one of passenger seats supported by the support member comprises either one of plural front-row seats which are disposed side by side in a vehicle width direction, another seat located beside the either one seat includes a seat back which is configured so as to be selectively held in a standing state of a substantially upright position or in a lying state of a substantially horizontal position, and at a portion near the either one seat is provided a shift device operative to shift a state of the seat back between the standing state and said lying state.

Accordingly, when one of the plural front-row seats disposed side by side is used as the above-described temporary baby-care bed, the seat back of another seat beside this seat can be used as a tray or the like on which any articles are placed temporarily, by shifting the seat back's state from its standing state to its lying state via the shift device provided at the seat.

According to another preferred embodiment, at least one of passenger seats supported by the support member is located substantially at a side of the ingress-and-egress opening portion, there is provided a rotational support mechanism to support at least one of passenger seats rotatably around a rotational axis extending in a substantially vertical direction, whereby the at least one of passenger seats can be selectively held in a state where a back face of the seat back thereof turns rearward or in a state where the back face of the seat back thereof turns toward the ingress-and-egress opening portion.

Accordingly, when the seat is used as the temporary baby-care bed after rotating the seat such that the back face of its seat back turns toward the ingress-and-egress opening portion, the care of the baby on the bed can be properly conducted through the ingress-and-egress opening portion from the outside of vehicle.

According to another preferred embodiment, there are provided a hinge door to open and close the ingress-and-egress opening portion by rotating around a door hinge and a slide door to open and close the ingress-and-egress opening portion by sliding in the longitudinal direction of the vehicle, and at least one of passenger seats supported by the support member and equipped with the rotational support mechanism is located at a portion corresponding to the slide door.

Accordingly, when the seat is rotated such that the back face of its seat back turns toward the ingress-and-egress opening portion and the ingress-and-egress opening portion beside the rotated seat is opened widely, the wide space can be provided beside the seat and therefore the care of the baby on the bed can be conducted easily.

Other features, aspects and advantages of the present invention will become apparent from the following description which refers to the accompanying drawings.

### BRIEF DESCRIPTION OF THE DRAWINGS

FIG. 1 is a side view showing a seat device of a vehicle according to an embodiment of the present invention.

FIG. 2 is a sectional elevation view showing a specific structure of a disposed portion of a front-row seat.

FIG. 3 is a plan view showing a specific structure of a floor panel.

FIG. 4 is a perspective view showing the specific structure of the floor panel.

FIG. 5 is a plan view showing a structure below the floor panel.

FIG. 6 is a sectional side view showing a specific structure of the floor panel.

FIG. 7 is an explanatory diagram showing a change of an assistant seat.

FIG. 8 is an explanatory diagram showing a state of the assistant seat which has been moved forward.

FIG. 9 is an explanatory diagram showing a use state of the seat device of the vehicle.

FIG. 10 is an explanatory diagram showing a state of the assistant seat stored forward.

FIG. 11 is an explanatory diagram showing another use state of the seat device of the vehicle.

FIG. 12 is an explanatory diagram showing a state of the front-row seat with its seat cushion which is positioned in a slant state.

FIG. 13 is a perspective view showing an example in which a seat cushion of a driver seat is held in a lying state.

FIG. 14 is an explanatory diagram showing a specific structure of a reclining mechanism.

FIG. 15 is an explanatory diagram showing a specific structure of a lock plate of the reclining mechanism.

FIG. 16 is an explanatory diagram showing a specific structure of an operating lever of the reclining mechanism.

FIG. 17 is an explanatory diagram showing the reclining mechanism equipped with a biasing member.

FIG. 18 is an explanatory diagram showing the reclining mechanism which is unlocked.

FIG. 19 is a plan view showing an arrangement of operating levers of the reclining mechanism and a slide engagement mechanism.

FIG. 20 is a perspective view showing a specific structure of the slide engagement mechanism.

FIG. 21 is a perspective view showing a specific structure of an engagement arm.

FIG. 22 is a plan view showing a seat device of a vehicle according to another embodiment of the present invention.

FIG. 23 is a side view showing the seat device of the vehicle according to the above-described embodiment of the present invention.

FIG. 24 is a plan view showing a use state of a first rear-row seat.

FIG. 25 is a plan view showing a seat device of a vehicle according to further another embodiment of the present invention.

FIG. 26 is an exploded perspective view showing a specific structure of a rotational support mechanism for a passenger seat.

### DETAILED DESCRIPTION OF THE INVENTION

Preferred embodiments of the present invention will be described referring to the accompanying drawings. It should be understood that even though embodiments are separately described, single features thereof may be combined to additional embodiments.

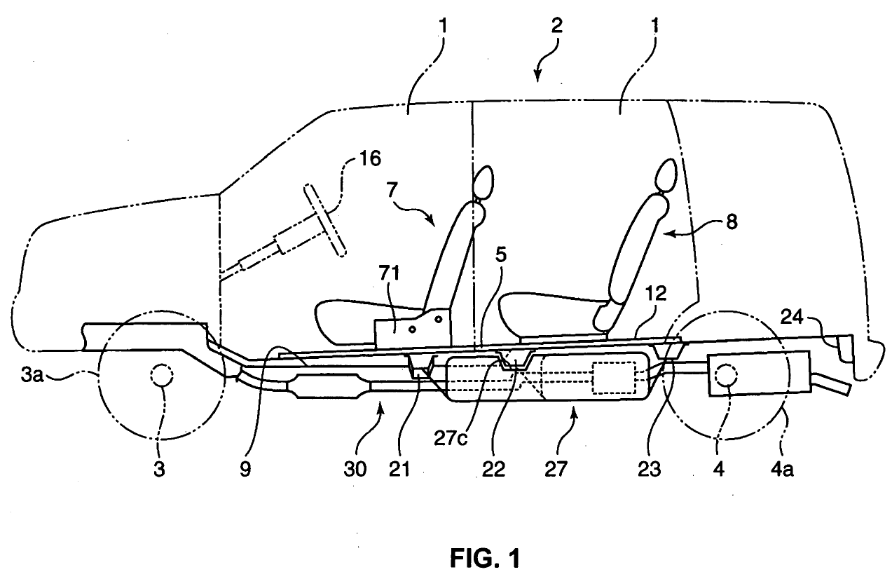

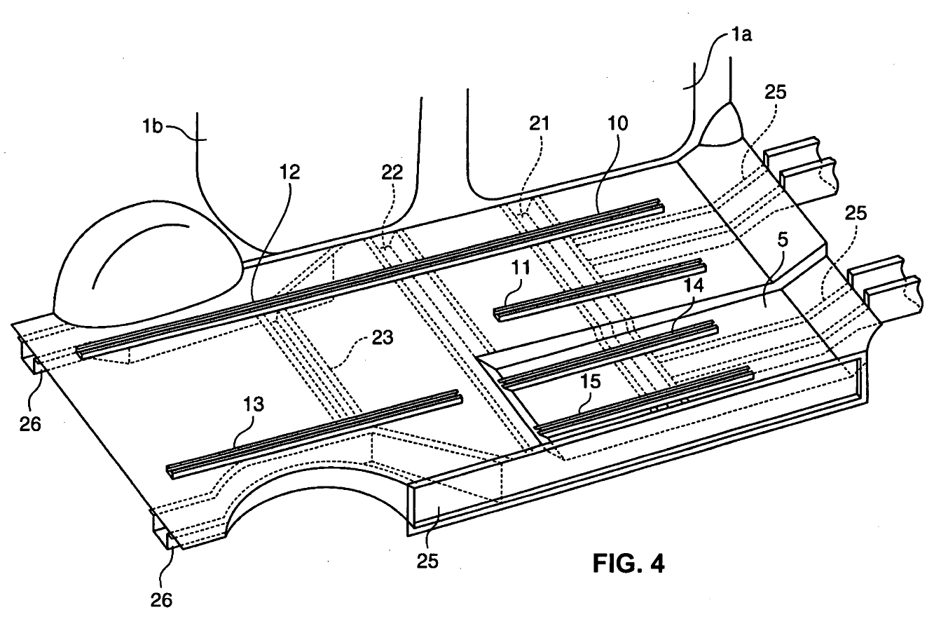

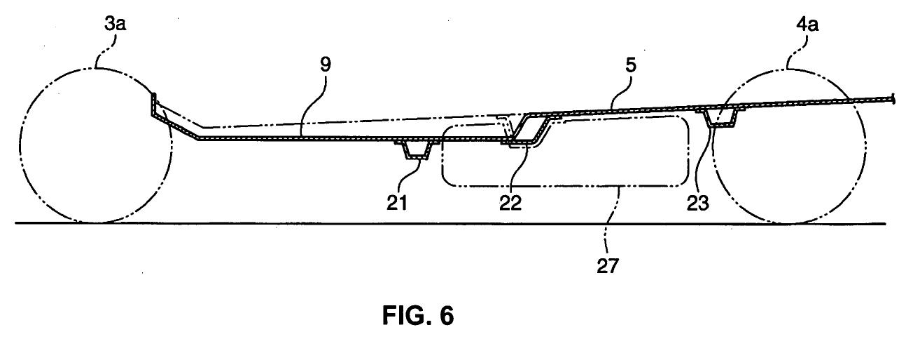

FIGS. 1 through 6 show a schematic structure of a vehicle equipped with a seat device of a vehicle according to an embodiment of the present invention. This vehicle is a so-called mini-van type of FF vehicle, in which a cabin 2 including an ingress-and-egress opening portion 1 on its side face is provided between a front-wheel axle 3 and a rear-wheel axle 4, and a vehicle engine (not illustrated) disposed at a front portion of a vehicle body drives a pair of front wheels 3a. Herein, a front door 1a and a rear door 1b are provided at the above-described ingress-and-egress opening portion 1 (see FIG. 4).

A floor panel 5 is provided at a lower portion of the cabin 2 between a right-and-left side sills 6, and plural passenger seats are provided on the floor panel 5. Namely, there are provided a front-row seat 7 comprising a driver seat 7a and an assistant seat 7b at a front portion of floor panel 5, and a rear-row seat 8 comprising a bench seat behind the front-row seat 7.

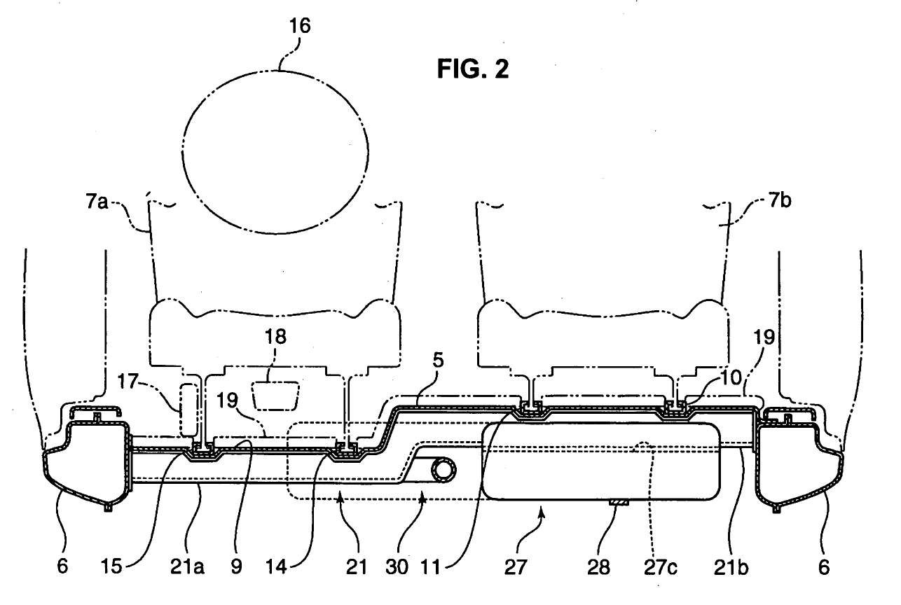

At a front portion of the cabin 2 on which the front-row seat 7 is placed are provided a low-floor portion with a low-level portion of floor panel 5 and a high-floor portion with a high-level portion of floor panel 5, which are disposed side by side in a vehicle width direction and constitute a difference in level (see FIG. 2). Specifically, a floor panel portion (hereinafter, referred to as “driver-seat placed portion”) on which the driver seat 7a is placed is positioned at a lower level compared to a floor panel portion (hereinafter, referred to as “other-passenger-seat placed portion”) on which other seats comprising the assistant seat 7b and the rear-row seat 8 are placed. Accordingly, a downward-recessed portion 9 is formed at the floor panel portion on which the driver seat 7a is placed, and a bottom face of this recess portion 9 constitutes the above-described low-floor panel portion, whereas the floor portion on which the assistant seat 7b is placed constitutes the above-described high-floor panel portion.

Also, the recess portion 9 is configured such that its bottom face is formed of a horizontal face which is substantially parallel to a contact surface (road surface) of the front and rear wheels 3a and 4a. Meanwhile, other portion of the floor panel 5 than the driver-seat placed portion, or the other-passenger-seat placed portion is formed of a flat face which is inclined over its entire length so that its rear is positioned at a higher level. Further, on the floor panel 5 are provided two pairs of right-and-left seat rails 10, 11 and 12, 13 which respectively support the assistant seat 7b and the rear-row seat 8 movably in the longitudinal direction of the vehicle. The left seat rail 12 of the rear-row seat 8 and the left seat rail 10 of the assistant seat 7b are continuously formed of a common rail member. Also, there are provided a pair of seat rails 14 and 15 to support the driver seat 7a movably in the longitudinal direction of the vehicle on the bottom face of the recess portion 9 at the driver-seat placed portion of the floor panel 5.

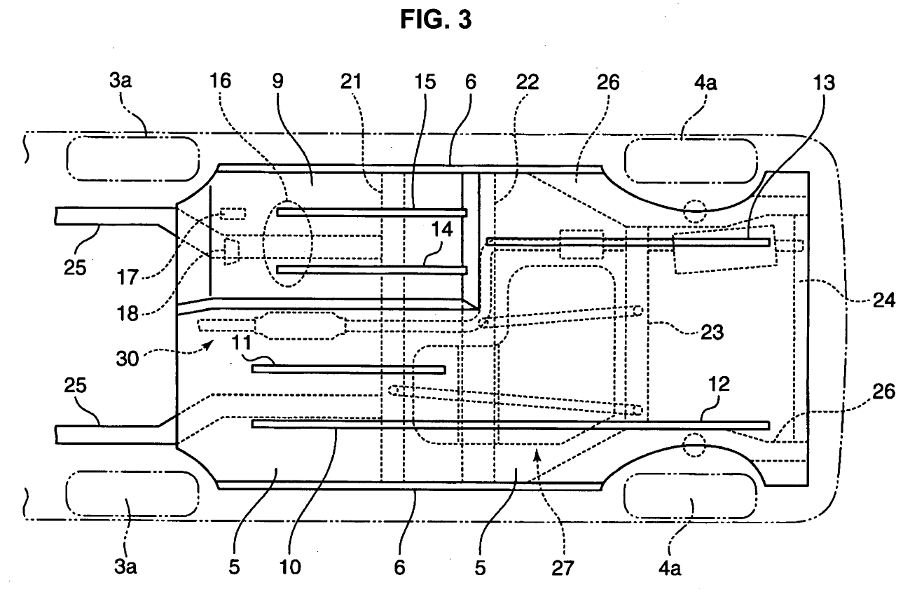

In FIGS. 2 and 3, reference numeral 16 denotes a steering wheel, reference numeral 17 denotes an accelerator pedal, reference numeral 18 denotes a brake pedal, and there is provided a carpet for vehicle 19 on the floor panel 5 to cover a portion other than a location of the seat rails 10 through 15, as shown by a two-dotted broken line in FIG. 2. Below the floor panel 5 are provided No. 2-No. 4 cross members 21 through 23 and a rear cross member 24, which extend in the vehicle width direction and are disposed separately from each other. Also, there are respectively provided a pair of right-and-left front frames 25 extending forward from the above-described No. 2 cross member 21, a pair of rear side frames 26 at the both sides of a rear portion of the floor panel 5, and the above-described side sills 6 at both-side end portions of the floor panel 5.

The No. 2 cross member 21 comprises a right-side portion 21a which is provided along the lower face of the recess portion 9 of the driver-seat placed portion, and a left-side portion 21b which is provided along the lower face of the floor panel of the assistant-seat placed portion. These portions 21a and 21b are disposed with a specified difference in level which corresponds to the difference in level between the above-described low-floor portion comprised of the bottom face of the recess portion 9 and the high-floor portion comprised of the floor panel face of the assistant-seat placed portion. Also, the No. 3 cross member 22 is disposed along the rear-end face of the recess portion 9, and a fuel tank 27 is disposed along the rear-end face and the inside face of the recess portion 9.

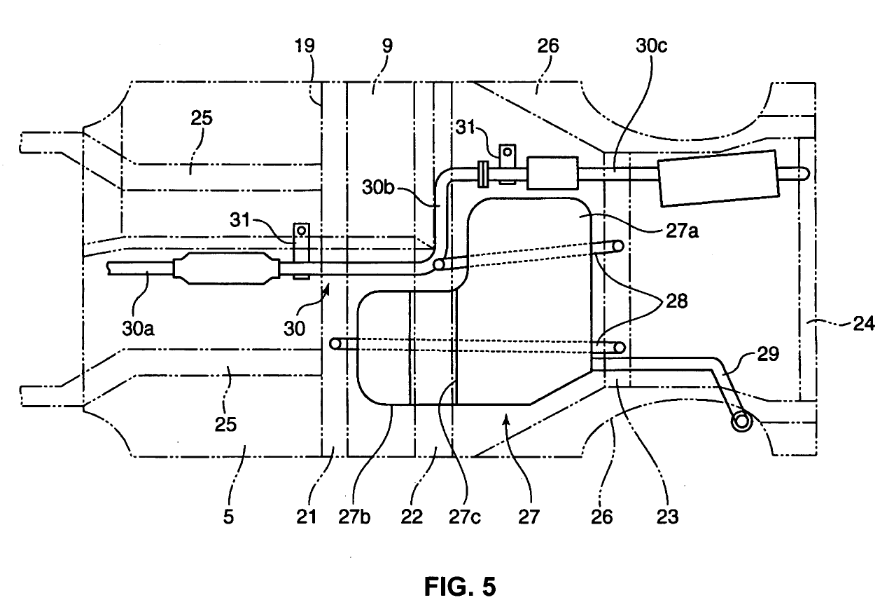

The above-described fuel tank 27 is of a L shape, when viewed from above, which comprises a tank-body portion 27a, which is provided below the rear-row seat 8 so as to extend in the vehicle width direction along the rear face of the No. 3 cross member 22, and a front-extending portion 27b, which is provided below the assistant seat 7b so as to extend forward along the inside face (a side face which is located at the inside of the vehicle) of the recess portion 9. The fuel tank 27 is supported at the No. 2-No. 4 cross members 21 through 23 via tank supporting bands 28, and a fuel supply pipe 29 is coupled to a rear wall of the fuel tank 27 (see FIG. 5). Also, a recess portion 27c is formed at the center of an upper face of the fuel tank 27 so as to extend in the vehicle width direction, corresponding to the No. 3 cross member 22. Accordingly, the No. 3 cross member 22 extending in the vehicle width direction along the center lower face of the floor panel 5 is disposed so as to cross over the upper face of the fuel tank 27.

Further, there is provided below the floor panel 5 an exhaust pipe 30, which comprises a front portion 30a extending rearward from an engine room along the side face of the recess portion 9, a central portion 30b extending in the vehicle width direction between the rear end face of the recess portion 9 and the fuel tank 27, and rear portion 30c extending rearward along the outside face of the fuel tank 27. This exhaust pipe 30 is attached to the lower face of the floor panel 5 via hangers 31.

And, the driver seat 7a is supported by the seat rails 14 and 15 provided in the recess portion 9 so as to move longitudinally within the area of the recess portion 9. The assistant seat 7b is supported by the seat rails 10 and 11 so as to move longitudinally within the area from the portion of the instrument panel located at the front end of the cabin 2 to the center of the cabin 2. Also, the rear-row seat 8 behind the front-row seat 7 is supported by the seat rails 12 and 13 so as to move within the area from the center to the rear end portion of the cabin 2.

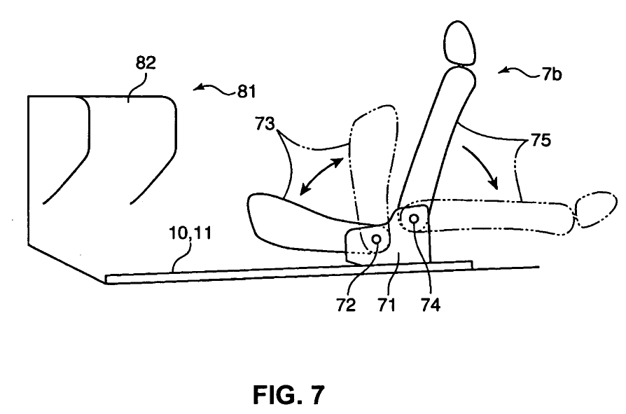

The assistant seat 7b comprises a seat cushion 73, as a sitting portion which the passenger sits on, and a seat back 75, as a back portion which the passenger leans against, as shown in FIG. 7. The seat cushion 73 is supported by the support member 71 via a pivotal axis 72, which is provided at the support member 71, in such a manner that the seat cushion 73 is selectively held in its normal sitting state of the substantially horizontal position with its front end face turning forward, or in its stored state, shown by the two-dotted broken line, of the substantially upright position with its front end in its sitting state located upward.

Also, the seat cushion 75 of the assistant seat 7b is supported by the support member 71 via another pivotal axis 74, which is provided rearward at the support member 71, in such a manner the seat back 75 is selectively held in its normal first-use state, shown by a solid line, of the substantially upright position, or in its second-use state, shown by the two-dotted broken line, of the substantially horizontal position with its lower end in its first-use state located forward.

Herein, the pivotal axes 72 and 74, which pivotally support the seat cushion 73 and the seat back 75 of the assistant seat 7b respectively, may be formed integrally at the seat cushion 73 and the seat back 75, or at respective brackets which are attached to the seat cushion 73 and the seat back 75 respectively.

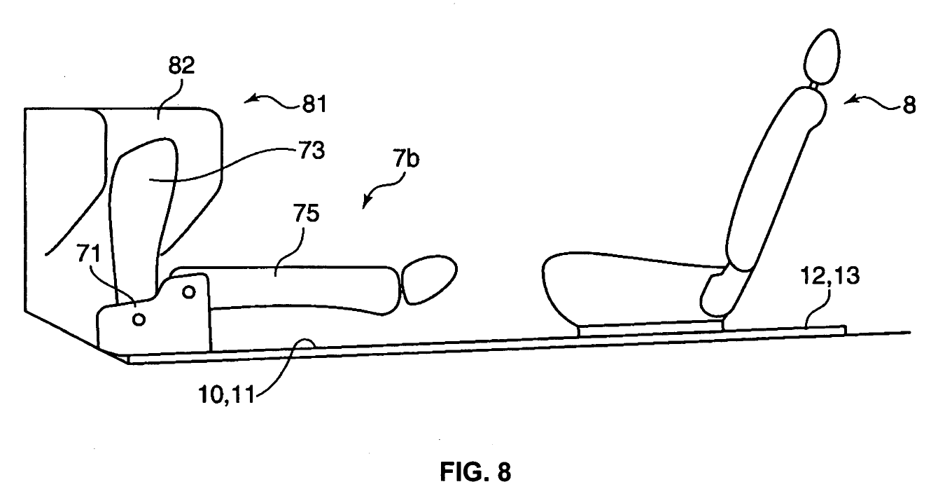

And, as shown in FIG. 8, by moving the assistant seat 7b to the front end of the cabin 2 along the seat rails 10 and 11 with the seat cushion 73 being held in its stored state of the substantially upright position and the seat back 75 being held in its second-use state of the substantially horizontal position, the assistant seat 7b can be used as the temporary baby-care bed, in which the seat back 75 performs as a bed body and the seat cushion 73 performs as a protect member.

Also, at a left side portion of the instrument panel 81 located at the front end portion of the cabin 2, which corresponds to a portion located in front of the assistant seat 7b, is formed a storing portion 82 which corresponds to the seat cushion 73 in its stored state of the substantially upright position. Accordingly, by moving the assistant seat 7b forward, the seat cushion 73 held in its stored sate can be stored in the above-described storing portion 82 formed at the instrument panel 81.

As described above, there is provided the support member 71 operative to support the seat cushion 73 and the seat back 75 of the assistant seat 7b as one of passenger seats in such a manner that the seat cushion 73 is selectively held in its normal sitting state of the substantially horizontal position with its front end face turning forward or in its stored state of the substantially upright position with its front end in its sitting state located upward, whereas the seat back 75 is selectively held in its first-use state of the substantially upright position or in its second-use state of the substantially horizontal position with its lower end in its first-use state located forward. And, further there are provided seat rails 10 and 11 operative to support the above-described passenger seat movably in the longitudinal direction of the vehicle to the front end potion of the cabin 2. Accordingly, by moving the assistant seat 7b forward along the seat rails 10 and 11 as shown in FIG. 8, the assistant seat 7b can be used as the temporary baby-care bed in which the seat back 75 having a larger area compared to the seat cushion 73 performs as the bed body and the seat cushion 73 performs as the protect member. And, a baby or the like can be laid down stably on this temporary bed of the assistant seat 7b for sleeping, and the care of baby can be conducted properly after moving this temporary bed forward in the vehicle.

Also, in the above-described embodiment, the assistant seat 7b disposed at the front portion in the cabin 2 is used as the temporary baby-care bed by providing the support member 71 supporting the seat cushion 73 and the seat back 75 so as to hold them in their respective states, and there is provided the rear-row seat 8 behind it. Accordingly, a large utility space can be made in front of the rear-row seat 8 by locating the temporary baby-care bed of the assistant seat 7b at the front portion in the cabin 2. Therefore, the passenger can easily and properly conduct the care of the baby lying on the temporary baby-care bed of the assistant seat 7b, such as the diaper changing, sitting on the rear-row seat 8.

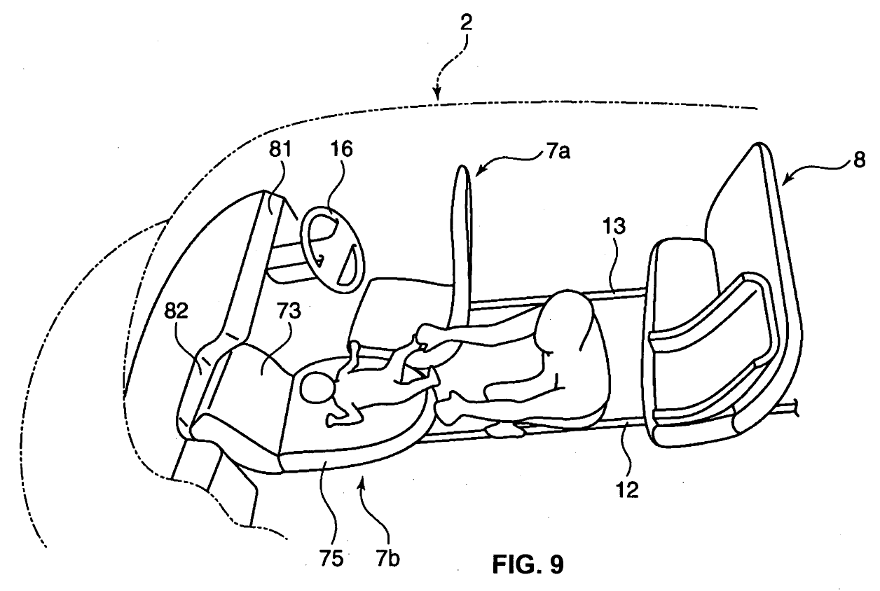

Particularly, in the case where the rear-row seat 8 is supported by the seat rails 12 and 13 movably in the longitudinal direction of the vehicle like the embodiment described above, a sufficiently large utility space can be made behind the temporary baby-care bed of the assistant seat 7b as shown in FIG. 9, by moving the rear-row seat 8 rearward and moving the temporary baby-care bed forward in the cabin 2. Accordingly, it is also possible that the passenger on the rear-row seat 8 conducts the diaper changing or the like, on passenger's knees upon the vehicle floor, and therefore such a baby care can be conducted more effectively.

Also, in the above-described embodiment, there is provided the instrument panel 81 extending in the vehicle width direction at the front end portion of the cabin 2, the recessed storing portion 82 is formed at the portion of the instrument panel 81 which corresponds to at least part of the assistant seat 7b, and the assistant seat 7b moves forward, whereby at least part of the assistant seat 7b can be stored in the storing portion 82 of the instrument panel 81. Accordingly, by further moving the assistant seat 7b forward by a distance which corresponds to a recess of the storing portion 82, much larger space can be made behind the temporary baby-care bed of the assistant seat 7b.

Namely, according to the above-described embodiment as shown in FIGS. 8 and 9, the storing portion 82, in which the seat back 73 of the assistant seat 7b held in its stored state of the substantially upright position is to be stored, is formed at the instrument panel 81, and the assistant seat 7b moves forward with the seat cushion 73 held in its stored state, whereby the seat cushion 73 can be stored in the storing portion 82. Accordingly, the rear space behind the assistant seat 7b can be enlarged effectively. Further, the assistant seat 7b can be used as the temporary baby-care bed, providing such an enlarged utility rear space behind the assistant seat 7b when the seat back 75 of the assistant seat 7b is held in its second-use state of the substantially horizontal position.

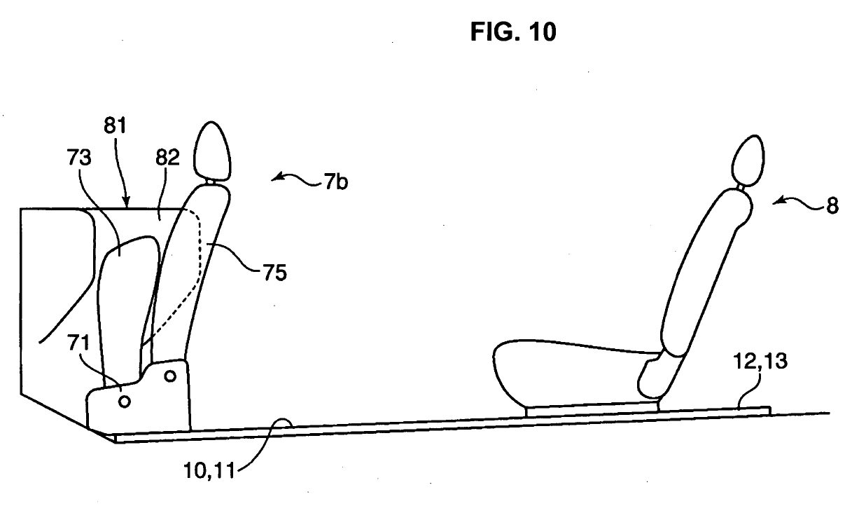

Also, in the case as shown in FIG. 10 where the recessed storing portion 82, in which the seat back 73 and seat back 75 of the assistant seat 7b held in their upright positions are to be stored, is formed at the instrument panel 81, and both the seat cushion 73 and seat back 75 are stored in the storing portion 82, the rear space behind the stored assistant seat 7b can be further enlarged, so that the passenger of the rear-row seat 8 can easily get on or get off and the residential space for the passenger can be greatly improved. And, the passenger's movement between the driver seat 7a and the rear-row seat 8 can be facilitated.

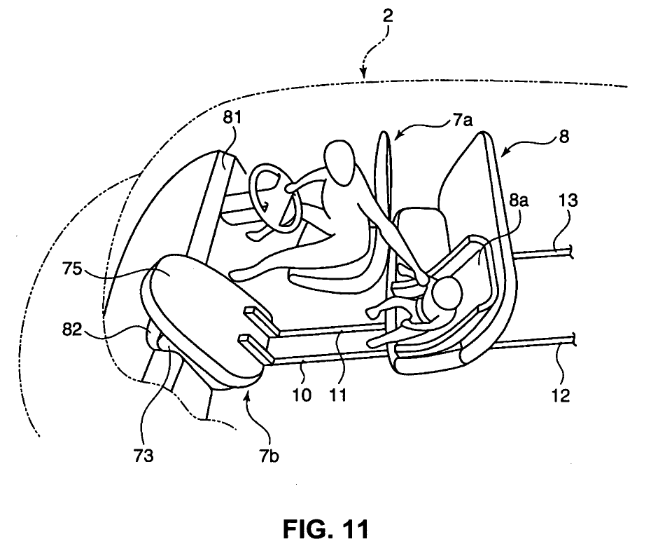

Further, as shown in FIG. 11, by storing the assistant seat 7b after its being moved to the front end portion of the cabin 2 along the seat rails 10 and 11 and moving forward the rear-row seat 8 to the center of the cabin 2 along the seat rails 12 and 13, the driver on the driver seat 7a can easily take care of a child on a childe seat 8a located on the rear-row seat 8 during a vehicle stop and the like. Also, such a forward movement of the rear-row seat 8 along the seat rails 12 and 13 can enlarge a space in a luggage room at a rear portion of the vehicle.

Herein, in the case as shown in the embodiment where at least part of the seat rail supporting the assistant seat 7b movably in the longitudinal direction of the vehicle and at least part of the seat rail supporting the rear-row seat 8 movably in the longitudinal direction of the vehicle, i.e., the left-side-located side rails 10 and 12, are formed of the common rail member, manufacturing costs can be reduced with a decrease of the number of parts, and an attachment rigidity of the seat rails can be strengthened effectively, facilitating attachment works of the seat rails 10 and 12. Herein, the seat rails 10 and 12 may be made separately, instead of the above-described embodiment.

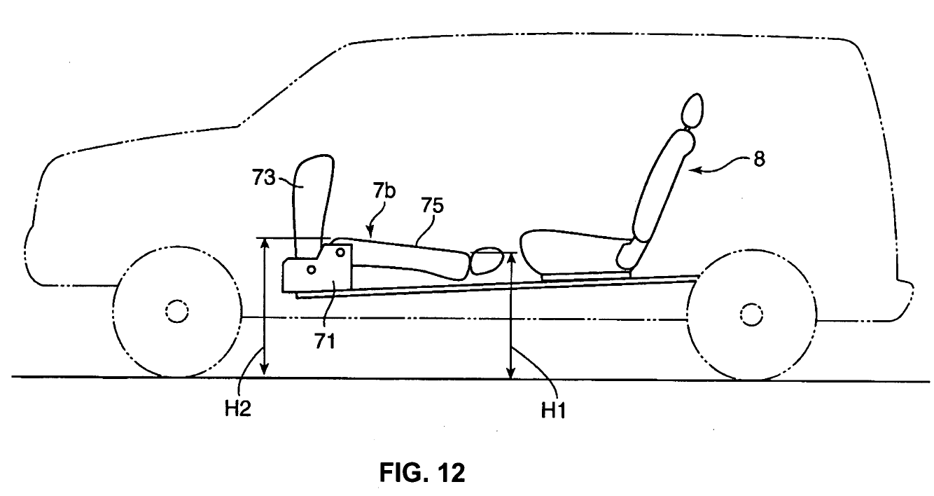

Also, as shown in FIG. 12, the seat back 75 of the assistant seat 7b supported by the support member 71 held in its second-use state of the substantially horizontal position may be configured such that the height H1 of its rear end portion above a road surface is lower than the height H2 of its front end portion above the road surface, so that the seat back 75 is positioned in a slant state where its rear portion is low. In this case, the baby's head placed on the front end portion of the seat back 75 can be located at a higher level than the baby's feet placed on the rear end portion of the seat back 75 when the assistant seat 75 is used as the temporary baby-care bed. Accordingly, the care of the baby such as the diaper changing can be easily conducted, laying down the baby on the bed in the stable position.

Herein, there may be provided an angle adjusting device operative to adjust a setting angle of the seat back 75 of the assisting seat 7b and an inclined-state detecting device operative to detect an inclined state of the road surface, whereby the setting angle of the seat back 75 can be adjusted by the angle adjusting device according to a detected value of the inclined-state detecting device such that the height H1 of its rear end portion above the road surface is lower than the height H2 of its front end portion above the road surface. In this case, when the assistant seat 7b is used as the temporary baby-care bed or the like, the baby's head placed on the front end portion of the seat back 75 as the bed body can be always located at the higher level than the baby's feet placed on the rear end portion of the seat back 75 regardless of the inclined state of the road surface. Therefore, the baby can be laid down on the bed in its stable position.

Also, as shown in FIG. 13, either one of plural passenger seats disposed side by side in the vehicle width direction, which is supported by the support member 71, may be comprised of the assistant seat 7b, at another seat located beside the assistant seat 7b, i.e., the driver seat 7a, may be provided a reclining mechanism which supports its seat back 75 such that its seat back 75 is selectively held in a standing state of a substantially upright position shown by a solid line in the figure or in a lying state of a substantially horizontal position by rotating it forward as shown by an arrow A, and at a portion near the assistant seat 7b may be provided a shift device comprised of an operating lever 76 to shift the state of seat back 75 between its standing state and its lying state.

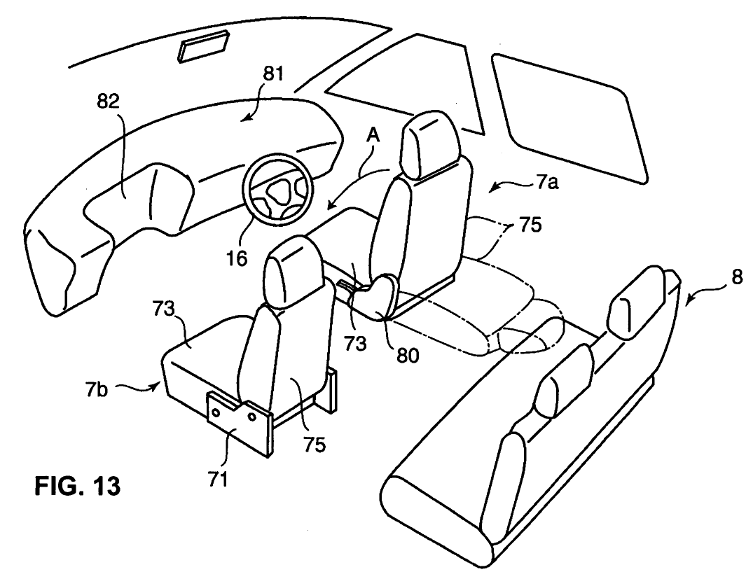

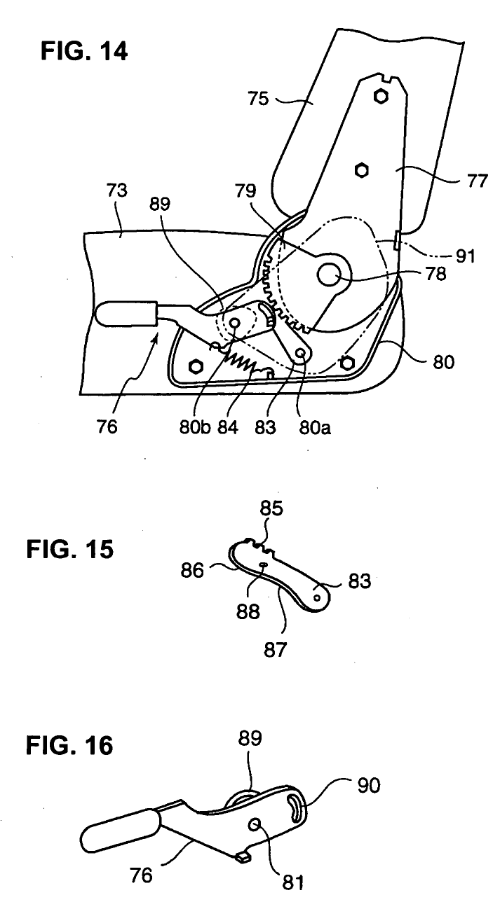

The above-described reclining mechanism, as shown in FIG. 14, comprises a connecting member 77 attached to a lower side face of the seat back 75, a sector gear 79 fixed to a pivotal axis 78 to pivotally support the connecting member 77, a base plate 80 attached to a rear side face of the seat cushion 73, a lock plate 83 and an operating lever 76 which are pivotally supported at the base plate 80 via pivotal axes 80a and 80b respectively, and a tension spring 84 operative to push down the operating lever 76 around the pivotal axis 80b.

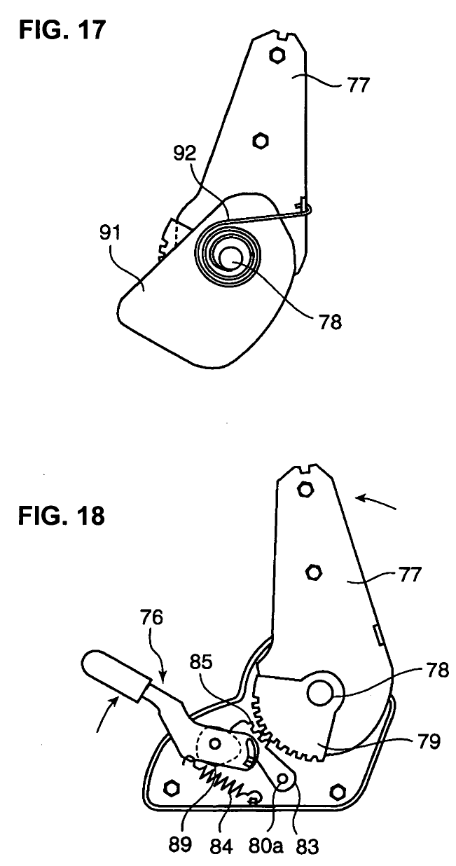

The lock plate 83, as shown in FIG. 15, has a gear portion 85 which is formed at an upper peripheral portion thereof and meshes with the above-described sector gear 79, an arc-shaped protruding portion 86 and a recess portion which are formed at a lower peripheral portion thereof, and a projection 8 which is formed on an outside face thereof and engages in a guide groove 90 of the operating lever 76 described below. Also, the operating lever 76, as shown in FIG. 16, has a cam 89 which is fixed to an inner side face thereof and the guide groove 90, which the projection 88 of the lock lever 80 engages in, which is formed at a base end portion thereof. Further, between the above-described connecting member 77 and an engagement member 91 fixed to the base plate 80 is provided a biasing member 92 comprised of a torsion spring which biases the connecting member 77 counterclockwise, as shown in FIG. 17.

The seat back 75 is held in its standing sate as shown in FIG. 14 during its normal sate, due to a restriction of the rotation of the sector gear 79 and connecting member 77 by locking the engagement of the gear portion 85 with the sector gear 79 according to the lock plate 83 being pushed toward the sector gear 79 by the cam 89. Then, when the pushing of the lock plate 83 by the cam 89 is released by operating the operating lever 76 upward, the gear portion 85 of the lock plate 83 is disengaged with the sector gear 79, resulting in an unlocked sate as shown in FIG. 18. Accordingly, the connecting member 77 is rotated counterclockwise by a biasing force of the above-described biasing member 92, and then the seat back 75 is folded on the seat cushion 73.

Also, a setting angle of the seat back 75 of the driver seat 7a is adjustable between its standing state of the substantially upright position and its lying state of the substantially horizontal position with its lower end portion in its standing state located forward (as shown by the two-dotted broken line in FIG. 13) within an engagement range of the sector gear 79 with the gear portion 85 of the lock plate 83, by reclining the seat back 75 rearward during the unlocked state of the connecting member 77.

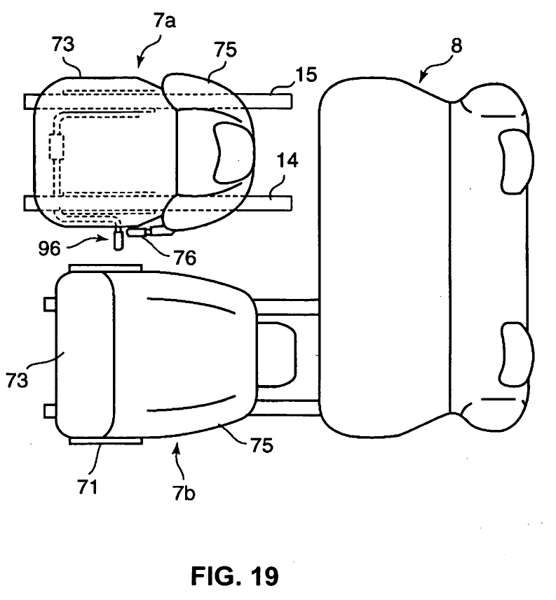

There is provided, as described above, a sift mechanism comprised of the reclining mechanism which can shift the seat back 75 of the driver seat 7a between its standing sate of the substantially upright position and its lying sate of the substantially horizontal position, and a shifting device comprised of the operating lever 76 operative to operate the above-described shifting mechanism is disposed near the assistant seat 7b, i.e., on a side wall face of the driver seat 7a beside the assistant seat 7b. In this case, as shown in FIG. 19, when the either one (the assistant seat 7b) of the plural front-row seats 7 disposed side by side in the vehicle width direction is used as the temporary baby-care bed, the seat back 75 of the other seat (the driver seat 7a) can be shifted from its standing sate of the substantially upright position to its lying state of the substantially horizontal position by the passenger on the rear-row seat 8 operating the operating lever 76, thereby facilitating a folding operation of the seat back 75 on the seat cushion 73. Accordingly, the passenger on the rear-row seat 8 can use properly the back face of the seat back 75 of the driver seat 7a as a tray or the like on which any articles are placed temporarily when taking care of the baby on the temporary baby-care bed comprised of the assistant seat 7b.

Further, in the case where the seat back 75 of the driver seat 7a is reclined rearward to be held in its lying sate of the substantially horizontal position shown by the two-dotted broken line in FIG. 13, the passenger on the rear-row seat 8 can use properly both the seat cushion 73 and the back face of the seat back 75 of the driver seat 7a as the tray or the like on which any articles are placed temporarily when taking care of the baby on the temporary baby-care bed comprised of the assistant seat 7b.

Also, as shown in FIG. 19, at a specified portion near the assistant seat 7b may be provided an operating lever 96 of an engagement mechanism operative to adjust the driver seat 7a at any desired positions which movably slides in the longitudinal direction of the vehicle along the seat rails 14 and 15. In this case, the passenger on the rear-row seat 8 can properly adjust the longitudinal position of the driver seat 7a by operating the operating lever 96 to disengage the engagement mechanism for the driver seat 7a, resulting in a convenient use of the driver seat 7a as the tray or the like.

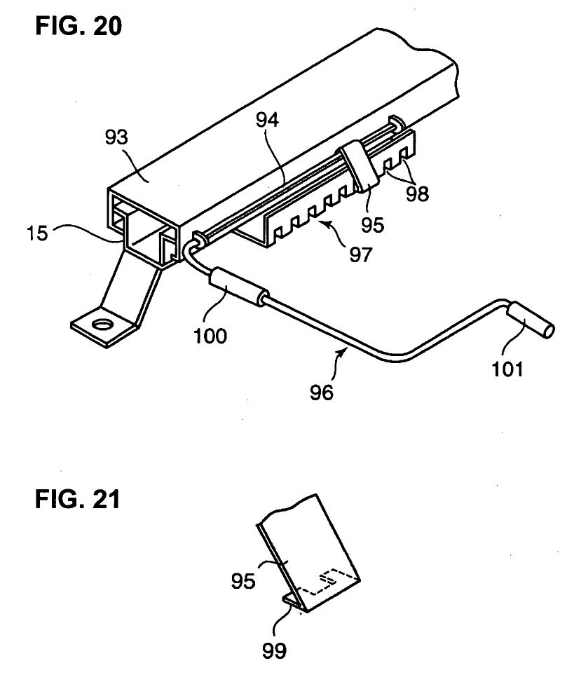

Namely, the above-described engagement mechanism, as shown, for example, in FIGS. 20 and 21, comprises a slide member 93 to be movably supported along the seat rail 15 and the like for the driver seat 7a, an acting rod 94 to be rotatably supported at the side face of the seat rail 15, an engagement arm 95 to be fixed to the acting rod 94, the above-described operating lever 96 to be connected to a tip of the acting rod 94 and extend outside, and an engagement member 97 to be attached to the side wall face of the seat rail 15. The operating lever 96 is provided such that it is bent rearward below the driver seat 7a and its tip projects toward the side of the assistant seat 7b.

The engagement member 97 has at its side face a tooth-shaped engagement portion 98, teeth of which are formed at regular intervals. The engagement arm 95 has an engagement portion 99 to engage with either one of teeth of the engagement portion 98 at its lower end portion. Normally, the engagement portion 99 of the engagement arm 95 is let engage with the engagement portion 98 by a biasing force of a biasing member (not illustrated) comprised of a torsion coil spring or the like, which is provided at the acting rod 94, thereby limiting a longitudinal movement of the slide member 93 and the driver seat. Also, rotating the operating lever 96 upward by operating a first grip 100 provided at the center of the operating lever 96 or a second grip 101 provided at a tip of the operating lever 96 lets the acting rod 94 rotate in its disengagement direction so that the engagement portion 99 of the engagement arm 95 can go away from the engagement portion 98 of the engagement member 97, resulting in a disengagement of the engagement mechanism for the driver seat 7a.

Accordingly, when the passenger on the rear-row seat 8 wants to use the diver seat 7a as the tray or the like on which any articles are placed temporarily, the driver seat 7a can be moved longitudinally with the disengagement of the engagement mechanism for the driver seat 7a by rotating the operating lever 96 upward by operating the second grip 101 provided at the side of the assistant seat 7b. Herein, when the passenger on the driver seat 7a wants to adjust the longitudinal position of the driver seat 7a, the driver seat 7a can be held in its adjustable sate with the disengagement of the engagement mechanism for the driver seat 7a by rotating the operating lever 96 upward by operating the second grip 101 provided at the side of the assistant seat 7b.

Herein, the above-described embodiment shows one example in which the seat cushion 73 of the assistant seat 7b disposed at the front portion in the cabin 2 is selectively held in its sitting state or its stored state and the seat back 75 is selectively held in its first-use state or its second-use state, whereby the assistant seat 7b can be used as the temporary baby-care bed. However, the driver seat 7a may be used as the temporary baby-care bed in place of the assistant seat 7b, or the front-row seat 7 comprised of the driver seat 7a along with the assistant seat 7b may be also used as the temporary baby-care bed. Also, the rear-row seat 8 may be used as the temporary baby-care bed with a structure in which the seat cushion of the rear-row seat 8 disposed behind the front-row seat 7 is selectively held in its sitting state or its stored state and its seat back is selectively held in its first-use state or its second-use state.

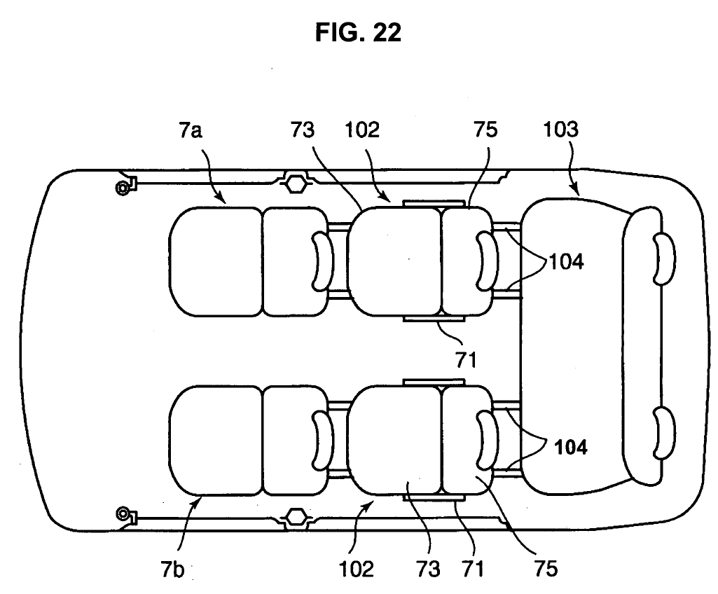

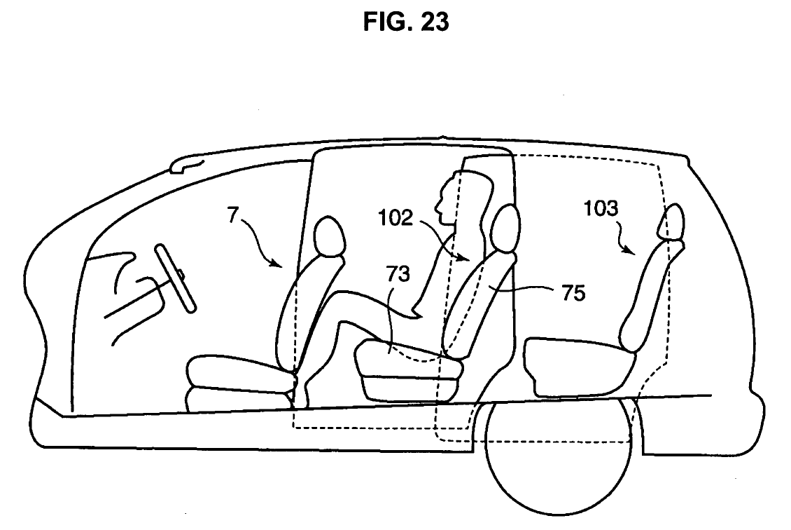

Further, in a three-row seat type of vehicle with a first-rear-row seat 102 and a second-rear-row seat 103, which are disposed behind the front-row seat 7, shown in FIGS. 22 and 23, there may be provided a support member 71 operative to support a seat cushion 73 and a seat back 75 of the first-rear-row seat 102 in such a manner that the seat cushion 73 is selectively held in its normal sitting state of the substantially horizontal position or in its stored state of the substantially upright position with its front end in the sitting state located upward, whereas the seat back 75 is selectively held in the above-described first-use state or in the second-use state.

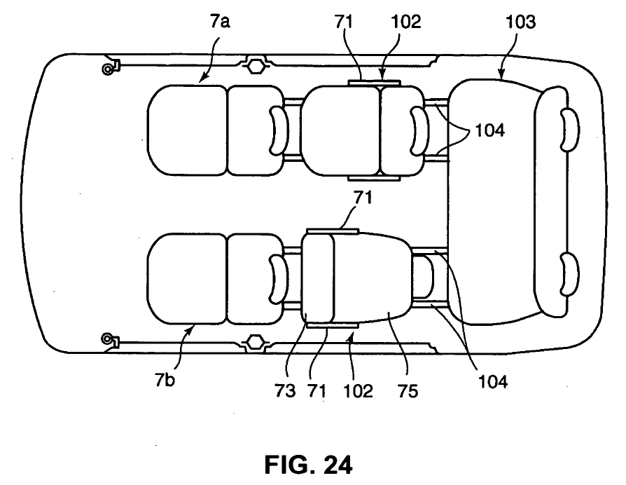

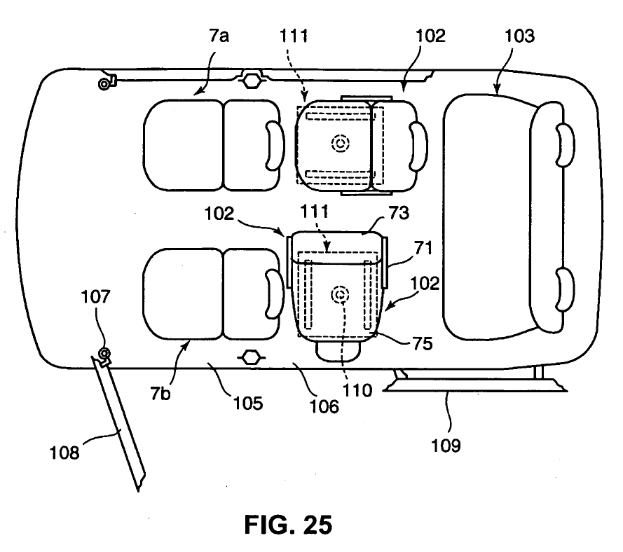

In this case, as shown, for example, in FIG. 24, the seat cushion 73 of the first-rear-row seat 102 (a left-side-located rear-row seat) behind the assistant seat 7b or the like is held in its substantially upright position and the seat back 75 of the first-rear-row seat 102 is held in its second-use sate of the substantially horizontal position, whereby the first-rear-row seat 102 can be used as the temporary baby-care bed and the passenger on the third-rear-row seat 103 can easily and properly take care of the baby or the like on the bed comprised of the first-rear-row seat 102. Also, the first-rear-row seat 102 can be adjusted at an appropriate position for using it as the temporary baby-care bed by sliding the seat 102 in the longitudinal direction along the seat rail 104.

Further, FIG. 25 shows another example of a vehicle, in which ingress-and-egress opening portions 105 and 106 are formed at the side of the passenger seats and there are provided a hinge door 108 to open and close the front ingress-and-egress opening portion 105 by rotating around a door hinge 107 and a slide door 109 to open and close the rear ingress-and-egress opening portion 106 by sliding in the longitudinal direction of the vehicle. In this example, by use of a rotational support mechanism 111, which is disposed at a portion corresponding to the disposition of the slide door 109 and supports the first-rear-row seat 102 rotatably around a rotational axis 110 extending in the substantially vertical direction, the first-rear-row seat 102 may be selectively held in a normal state where a back face of its seat back 75 turns rearward or in a state where the back face of its seat back 75 turns toward the ingress-and-egress opening portion 106 as shown in FIG. 25.

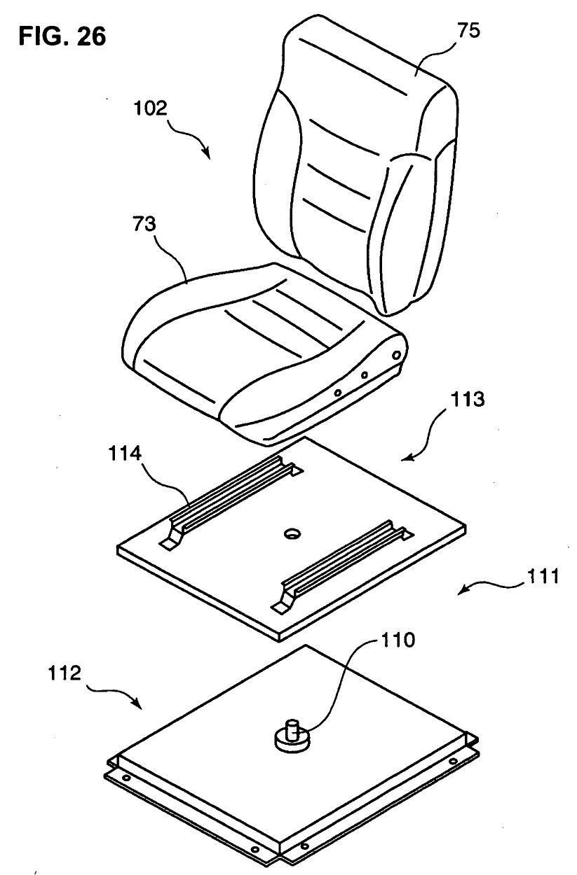

FIG. 26 shows an exemplified specific structure of the above-described rotational support mechanism 111, in which there are provided a fixed plate 112 fixed to the vehicle body and a rotary plate 113 to be supported rotatably around the rotational axis 110 provided at the fixed plate 112, and the first-rear-row seat 102 is supported so as to slide along the seat rail 114 on the rotary plate 113. By rotating the rotary plate 113 around the rotational axis, the first-rear-row seat 102 is configured so as to be selectively held in the normal state where the back face of its seat back 75 turns rearward (see FIG. 22) or in the state where the back face of its seat back 75 turns toward the ingress-and-egress opening portion 106 (see FIG. 25) and the first-rear-row seat 102 is also supported so as to slide along the seat rail 114.

In this case, the first-rear-row seat 102 can be used as the temporary baby-care bed, by rotating the seat 102 in such a manner that the back face of its seat back 75 turns toward the ingress-and-egress opening portion 106, and then holding the seat back 75 in its lying state with its upper end located at the outside of the vehicle along with the seat cushion 73 being in its upright position. Also, when the slide door 109 is opened, the care of the baby on the bed can be easily conducted through the ingress-and-egress opening portion 106 from the outside of vehicle. Further, the first-rear-row seat 102 can be moved to any positions where the care of the baby or the like on the bed can be easily and properly conducted, by sliding the first-rear-row seat 102 along the seat rail 114 when the back face of its seat back 75 turns toward the ingress-and-egress opening portion 106.

Further, according to the above-described embodiment of the vehicle in which there are provided the hinge door 108 to open and close the front ingress-and-egress opening portion 105 by rotating around the door hinge 107 and the slide door 109 to open and close the rear ingress-and-egress opening portion 106, the first-rear-row seat 102 including the above-descried support member 71 and rotational support mechanism 111 is disposed at the portion which corresponds to the disposition of the slide door 109. Accordingly, when the first-rear-row seat 102 is rotated such that the back face of its seat back 75 turns toward the ingress-and-egress opening portion 106 and the ingress-and-egress opening portion 106 beside the rotated seat 102 is opened widely sliding rearward, the care of the baby on the bed can be conducted easily.

Herein, instead of the above-described embodiment in which the first-rear-row seat 102 is rotated around the rotational axis 110 extending vertically such that the back face of its seat back 75 turns toward the ingress-and-egress opening portion 106, the assistant seat 7b of the front-row seat 7 may be supported rotatably around a rotational axis vertically or the rearmost second-rear-row seat 103 may be comprised of right and left seats which are separate from each other, and the seats may be shifted such that the back faces of these seats turn toward the ingress-and-egress opening portion, whereby these seat backs can be used as the temporary baby-care bed.

Further, according to the above-described embodiment in which the driver-seat placed portion of the floor panel 5 constitutes the low-floor panel portion, the assistant-seat placed portion of the floor panel 5 constitutes the high-floor panel portion, the downward-recessed portion 9 is formed at the portion of the floor panel 5 on which the deriver seat 7a is placed, and the fuel tank 27 is disposed so as to cover part of the recess portion 9, i.e., part of the inside face and the rear end face of the recess portion 9, there can be provided an enough space at the foot portion of the driver seat 7a so that the driver can easily get on or get off. Also, the residential space for the passenger on the driver seat 7a can be improved by providing a sufficient amount of vertical movement in shifting the driving position of driver with respect to the driving seat 7a. Also, the fuel tank 27 with a large volume can be disposed efficiently by utilizing the large space formed below the floor panel portion at the assistant seat 7b.

Also, according to the above-described embodiment in which there are provided the front-row seat 7 comprising the driver seat 7a and the assistant seat 7b at the front portion in the cabin 2 and the rear-row seat 8 disposed behind the front-row seat 7, and the L-shaped fuel tank 27, when viewed from above, including the tank-body portion 27a provided below the rear-row seat 8 and the front-extending portion 27b extending below the assistant seat 7b is disposed at the high-floor panel portion, the volume of the fuel tank 27 can be made large. Further, the fuel tank 27, which may become heavy when it is fully filled, can be located closer to the gravity center of the vehicle which is positioned at the center of the cabin 2, and therefore the inner moment occurring during the vehicle turning can be reduced effectively.

Herein, the fuel tank 27 may be formed separately into the tank-body portion 27a and the front-extending portion 27b. In this case, however, a connecting pipe to interconnect these portions 27a and 27b is necessary, resulting in a complex structure. Also, since some supporting members for supporting portions 27a and 27b respectively at the vehicle body are necessary, supporting works of the fuel tank 27 may be complex as well. For this reason, the above-described structure may be more preferable, in which the L-shaped fuel tank 27 with the tank-body portion 27a and the front-extending portion 27b is integrally disposed at the high-floor panel portion of the floor panel 5.

Also, according to the above-described embodiment in which the exhaust pipe 30 is disposed between the recess portion 9 and the fuel tank 27 which is disposed so as to enclose the recess portion 9 formed at the driver-seat placed portion, both the fuel tank 27 and the exhaust pipe 30 can be provided efficiently by using effectively the space below the floor panel 5, avoiding a high floor of the floor panel 5 which may be caused by putting one over another.

Further, according to the above-described embodiment in which other portion of the floor panel 5 than the driver-seat placed portion, or the other-passenger-seat placed portion at the assistant seat 7b and the rear-row seat 8 is formed of the flat face, the rail seats 10 through 13 can be disposed at appropriate locations on the other-passenger-seat placed portion, providing a sufficient designing flexibility of the space at this portion in the cabin 2. And, by utilizing the space below the floor panel portion at the other passenger seats 7b and 8, the flat and low floor of the floor panel 5 can be obtained, and the fuel tank 27, exhaust pipe 30 and the like can be easily and properly disposed.

Also, according to the above-described embodiment in which the other-passenger-seat placed portion of the floor panel 5 is disposed slant with its rear being positioned higher such that the rear space below the floor panel 5 is larger, the sufficiently large volume of the fuel tank 27 can be obtained by designing the tank with its thick rear portion. Further, a larger foot space of the passenger can be provided during their getting on or getting off the vehicle because the floor panel surface of the other-passenger-seat placed portion at the assistant seat 7b and the rear-row seat 8 is disposed slant with its front being positioned lower. Therefore, the passenger can easily get on or off the vehicle.

Further, according to the above-described embodiment in which the bottom face of the recess portion 9 formed at the driver-seat placed portion of the floor panel 5 is disposed horizontally, the vertical position of the driver seat 7a can be prevented from changing when the driver seat 7a is moved longitudinally along the guide rails 14 and 15 according to the body size of the driver. Accordingly, the driving position of the driver can be maintained stably. Also, the distance between the driver's head and a roof of the cabin 2 can be prevented from changing.

Namely, it may be possible that the bottom face of the recess portion 9 formed at the driver-seat placed portion of the floor panel 5 is disposed slant such that its rear is positioned higher, like the other-passenger-seat placed portion. In this case, however, the position of the driver seat 7a changes vertically according to the longitudinal moment of the driver seat 7a. Accordingly, the relative vertical position of the driver with respect to the steering wheel 16, accelerator pedal 17 and brake pedal 18 changes, so that the driving position may become unstable and the distance between the driver's head and the roof of the cabin 2 may become small inevitably according to the driver seat 7a moving rearward.

However, in the case where the bottom face of the recess portion 9 is disposed horizontally as described above, the relative position of the driver with respect to the steering wheel 16, accelerator pedal 17 and brake pedal 18 can be maintained to be constant regardless of the longitudinal movement of the driver seat 7a, and therefore the driving position can be made stable. Further, the distance between the driver's head and the roof of the cabin 2 can be maintained to be constant without any countermeasures, such as designing the roof of the cabin 2 to be located inappropriately higher or providing an additional device to lower the driver seat, in order to avoid the contact of the driver's head with the roof according to the driver seat 7a being moved rearward. Therefore, the comfortableness of the driver sitting on the driver seat 7a can be also effectively improved.

Also, according to the above-described embodiment in which the No. 3 cross member 22 extending laterally below the floor panel 5 is located crossing over the central portion of the fuel tank 27, the vehicle rigidity can be effectively strengthened against a vehicle side impact or the like by reinforcing the disposed portion of the fuel tank 27 effectively by the No. 3 cross member 22. And, the supporting strength of the fuel tank 27 can be effectively improved by making use of the No. 3 cross member 22 as the support member of the fuel tank 27.

Herein, the present invention should not limited to the above-described embodiments, but any other modifications and improvements may be applied within the scope of a spirit of the present invention.

1. A seat device of a vehicle, in which a cabin including an ingress-and-egress opening portion on a side face thereof is provided between a front-wheel axle and a rear-wheel axle, comprising:
plural passenger seats including a driver seat, which are disposed on a floor panel provided at a lower portion of the cabin;
a support member operative to support a seat cushion and a seat back of at least one of said passenger seats in such a manner that the seat cushion is selectively held in a sitting state of a substantially horizontal position or in a stored state of a substantially upright position with a front end thereof in the sitting state located upward, whereas the seat back is selectively held in a first-use state of a substantially upright position or in a second-use state of a substantially horizontal position with a lower end thereof in the first-use state located forward; and
a seat rail operative to support said at least one of passenger seats such that the at least one of passenger seats moves forward in a longitudinal direction of the vehicle.

2. The seat device of a vehicle of claim 1, wherein said at least one of passenger seats supported by said support member comprises a front-row seat which is located at a front portion in the cabin, and a rear-row seat is provided behind the front-row seat.

3. The seat device of a vehicle of claim 2, wherein there is provided an instrument panel extending in a vehicle width direction at a front end portion of the cabin, a recessed storing portion is formed at a portion of said instrument panel which corresponds to at least part of said front-row seat, and the front-row seat moves forward along said seat rail, whereby said at least part of the front-row seat can be stored in said storing portion.

4. The seat device of a vehicle of claim 3, wherein said front-row seat moves forward along said seat rail with the seat cushion thereof being held in said stored state, whereby the seat cushion of the front-row seat can be stored in said storing portion.

5. The seat device of a vehicle of claim 3, wherein said front-row seat moves forward along said seat rail with the seat cushion thereof being held in said stored state and with the seat back thereof being held in said first-use state, whereby the seat cushion and seat back of the front-row seat can be stored in said storing portion.

6. The seat device of a vehicle of claim 2, wherein at least part of the seat rail supporting said front-row seat movably in the longitudinal direction of the vehicle and at least part of the seat rail supporting said rear-row seat movably in the longitudinal direction of the vehicle are formed of a common rail member.

7. The seat device of a vehicle of claim 1, wherein the seat back of said at least one of passenger seats supported by said support member in said second-use state is configured such that a height of a rear end portion thereof above a road surface is lower than that of a front end portion thereof above the road surface.

8. The seat device of a vehicle of claim 2, wherein said at least one of passenger seats supported by said support member comprises either one of plural front-row seats which are disposed side by side in a vehicle width direction, another seat located beside said either one seat includes a seat back which is configured so as to be selectively held in a standing state of a substantially upright position or in a lying state of a substantially horizontal position, and at a portion near the either one seat is provided a shift device operative to shift a state of the seat back between said standing state and said lying state.

9. The seat device of a vehicle of claim 1, wherein said at least one of passenger seats supported by said support member is located substantially at a side of said ingress-and-egress opening portion, there is provided a rotational support mechanism to support said at least one of passenger seats rotatably around a rotational axis extending in a substantially vertical direction, whereby said at least one of passenger seats can be selectively held in a state where a back face of the seat back thereof turns rearward or in a state where the back face of the seat back thereof turns toward the ingress-and-egress opening portion.

10. The seat device of a vehicle of claim 9, wherein there are provided a hinge door to open and close the ingress-and-egress opening portion by rotating around a door hinge and a slide door to open and close the ingress-and-egress opening portion by sliding in the longitudinal direction of the vehicle, and said at least one of passenger seats supported by the support member and equipped with said rotational support mechanism is located at a portion corresponding to said slide door.
